(19) United States
(12) Patent Application Publication
(10) Pub. No.: US 2024/0096063 A1
(43) Pub. Date: Mar. 21, 2024

(54) INTEGRATING MODEL REUSE WITH MODEL RETRAINING FOR VIDEO ANALYTICS

(71) Applicant: Microsoft Technology Licensing, LLC, Redmond, WA (US)

(72) Inventors: Ganesh ANANTHANARAYANAN, Sammamish, WA (US); Yuanchao SHU, Kirkland, WA (US); Paramvir BAHL, Bellevue, WA (US); Tsuwang HSIEH, Sammamish, WA (US)

(73) Assignee: Microsoft Technology Licensing, LLC, Redmond, WA (US)

(21) Appl. No.: 18/078,402

(22) Filed: Dec. 9, 2022

Related U.S. Application Data
(60) Provisional application No. 63/408,712, filed on Sep. 21, 2022.

(51) Int. Cl. G06V 10/77

(52) U.S. Cl. CPC G06V 10/7715; G06V 2201/10

(57) ABSTRACT

Systems and methods are provided for reusing and retraining an image recognition model for video analytics. The image recognition model is used for inferring a frame of video data that is captured at edge devices. The edge devices periodically or under predetermined conditions transmits a captured frame of video data to perform inferencing. The disclosed technology is directed to select an image recognition model from a model store for reusing or for retraining. A model selector uses a gating network model to determine ranked candidate models for validation. The validation includes iterations of retraining the image recognition model and stopping the iteration when a rate of improving accuracy by retraining becomes smaller than the previous iteration step. Retraining a model includes generating reference data using a teacher model and retraining the model using the reference data. Integrating reuse and retraining of models enables improvement in accuracy and efficiency.

### CROSS-REFERENCE TO RELATED APPLICATIONS

This application claims priority to and the benefit of U.S. Provisional Patent Application No. 63/408,712, filed on Sep. 21, 2022, the disclosure of which is hereby incorporated herein by reference in its entirety.

### BACKGROUND

Technologies involving video analytics are becoming more and more important as widely distributed systems have become more available in our daily lives. For example, image/video cameras in edge devices of the 5G telecommunication networks continuously capture and transmit scenes as video data over the wireless network to the cloud. Video analytics includes accurately and efficiently recognizing features associated with content of video streams. Among the technological challenges associated with video analytics are maintaining an acceptable level of accuracy and efficiency even while content of the video data changes over time. For example, a video camera that captures a street scene may capture cars and trucks having different shapes, animals, pedestrians, people on scooters and bicycles, etc., during varying environmental conditions depending on the weather (e.g., sunny, cloudy, clear, foggy, rainy, snowy, etc.) and/or lighting at different times of the day (dawn, morning, midday, afternoon, dusk, nighttime, etc.).

Some video analytics continuously retrain models associated with object recognition for image and/or video data, which requires costly resource utilization and processing and may result in increased latency in both image recognition and model retraining. Thus, there is a need to optimize accuracy without sacrificing resource and time efficiencies. Furthermore, a video analytics system that is scalable is needed as the number of edge devices that capture video data continues to rapidly grow.

It is with respect to these and other general considerations that the aspects disclosed herein have been made. In addition, although relatively specific problems may be discussed, it should be understood that the examples should not be limited to solving the specific problems identified in the background or elsewhere in this disclosure.

### SUMMARY

Aspects of the present disclosure relate to a system for reusing and retraining models for video analytics. In aspects, an edge device captures video data, e.g., using a video camera or recorder. A model adaptation processor receives sample image data associated with at least one sample frame of the captured image data or video data. The model adaptation processor selects one or more candidate image recognition models from a trained model store based on the sample image data using a selection model associated with a gating network. Using reference image data that has been labeled, a safety checker validates the one or more candidate image recognition models by comparing image labeling by the respective one or more candidate image recognition models with the labeled reference image data and further selects, based on the comparison, an image recognition model of the one or more candidate image recognition models for reuse in labeling the received sample image data. The disclosure performs inferencing of subsequently captured image data using the selected image recognition model.

The disclosure further selects one or more image recognition models stored in the trained model store for retraining using the labeled reference image data and the sample image data. For example, retraining is done using training data that includes the sample image data and labeling that the teacher labeler implemented. Thus, the reference image data includes a set of sample image data that was previously received. The disclosure schedules the retraining using a queue for retraining models and allocates a micro window that corresponds to a unit of processor resources for retraining. The retraining includes iterations of retraining, where the iteration ends when a difference of improvement in a level of accuracy for labeling the sample image data is within a predetermined threshold. An iteration includes retraining using the training data.

This Summary is provided to introduce a selection of concepts in a simplified form, which is further described below in the Detailed Description. This Summary is not intended to identify key features or essential features of the claimed subject matter, nor is it intended to be used to limit the scope of the claimed subject matter. Additional aspects, features, and/or advantages of examples will be set forth in part in the following description and, in part, will be apparent from the description, or may be learned by practice of the disclosure.

### BRIEF DESCRIPTIONS OF THE DRAWINGS

Non-limiting and non-exhaustive examples are described with reference to the following figures.

FIG. 1 illustrates an overview of an example system for reusing and retraining data recognition model in accordance with aspects of the present disclosure.

FIG. 2 illustrates an overview of an example system reusing and retraining image recognition model for processing captured video data in accordance with aspects of the present disclosure.

FIG. 3A illustrates an example data associated with labeling image data in accordance with aspects of the present disclosure.

FIG. 3B illustrates an example system for reusing an image recognition model in accordance with aspects of the present disclosure.

FIG. 4 illustrates an example system for retraining an image recognition model in accordance with aspects of the present disclosure.

FIGS. 5A-C illustrate examples of methods for reusing and retraining an image recognition model in accordance with aspects of the present disclosure.

FIG. 6 illustrates an example of a computing device with which aspects of the present disclosure may be practiced.

FIG. 7A is a simplified diagram of a mobile computing device with which aspects of the present disclosure may be practiced.

FIG. 7B is another simplified block diagram of a mobile computing device with which aspects of the present disclosure may be practiced.

### DETAILED DESCRIPTION

There is an increasing number of remote video cameras or video recording devices that are placed both indoors and outdoors for varieties of reasons. For example, some video cameras are installed to capture street scenes for security purposes. Others are installed in automobiles to capture surroundings for detecting hazards and/or for autonomous vehicle navigation. The video cameras installed at remote locations may be connected wirelessly to the cloud through a variety computing networks, including the 5G (or 6G, et seq.) telecommunication network(s). Technologies associated with video analytics have become more demanding as the need for accurately and efficiently recognizing captured video data has increased.

There is a need for video analytics systems to maintain both a level of accuracy and efficiency in recognizing features of video data (e.g., image data) with changing environmental and other conditions. For example, content of captured video data may change over time depending on the time of the day and/or weather conditions. In addition to changes due to lighting and weather conditions, content of video data captured by a video camera on an automobile may substantially change over time as the automobile moves into different environments, e.g., to different terrain (e.g., rural, urban, mountainous, flat, etc.), different types of roadways (e.g., country roads, city streets, highways, etc.), and different roadway structures (e.g., tunnels, bridges, etc.). To maintain a level of accuracy for image recognition, some technologies include continuous retraining of image recognition models as a video camera continues to capture new content. The continuous learning of the model raises issues of high resource consumption and increased latencies in processing captured image data while continuously retraining the model.

In examples, continuous learning of models for video analytics uses a lightweight deep neural network model that is fine-tuned for recognizing specific video content to accommodate data drift, which is caused by changes of captured content over time. The continuous learning often suffers due to significant computing overhead leading to delays in the periodic retraining of the models. The heavy resource requirements of traditional continuous training of models also raises issues of scalability for image recognition systems.

As discussed in more detail below, the present disclosure relates to reusing and retraining image recognition models for video analytics. The present disclosure combines aspects of reusing a trained image processing model in a pool of trained image processing models with retraining previously trained image processing models when needed. The present disclosure improves both an accuracy and an efficiency of recognizing captured image data by selecting and reusing a trained image processing model that is suitable for recognizing particular types of content of captured image data from a pool of trained image recognition models. The disclosed technology retrains an image recognition model when needed based on sampled image data and updates the pool of trained image recognition models.

The disclosed technology enables quickly adapting an expert model to video frame samples as captured by a video camera in an edge device. In particular, the disclosure is directed to maintaining a pool of trained models (e.g., “a model zoo” or a trained model store). The pool of models includes image recognition models that have been previously trained for an edge device such that the models may be “reused” for inferencing features (e.g., labeling) of image data for incoming video data. A plurality of adaptation processors may share the pool of models. The disclosed technology uses a procedure to efficiently select a highly accurate expert model (e.g., a trained image recognition model) from the pool of models based on sample image data of an incoming video. The disclosed technology further dynamically optimizes computing resource allocations for one or more processors including but not limited to a graphical processing unit (GPU) for model retraining, model selection, and inferencing video data based on a selected model. Integrating model reuse and model retraining in effect reduces consumption of computing resources while at least maintaining levels of both accuracy and performance in inferencing image data.

Reuse and retraining of models according to the present disclosure are not limited to image recognition models for video analytics. Additionally, or alternatively, the disclosed technology may reuse and retrain models for analytics of data other than video, including but not limited to textual data and audio data for example. The disclosed technology addresses the issue of data processing models that suffers from a drift of data by reusing and retraining the data processing models.

Various aspects of the disclosure are described more fully below with reference to the accompanying drawings, which from a part hereof, and which show specific example aspects. However, different aspects of the disclosure may be implemented in many different ways and should not be construed as limited to the aspects set forth herein; rather, these aspects are provided so that this disclosure will be thorough and complete, and will fully convey the scope of the aspects to those skilled in the art. Practicing aspects may be as methods, systems, or devices. Accordingly, aspects may take the form of a hardware implementation, an entirely software implementation or an implementation combining software and hardware aspects. The following detailed description is, therefore, not to be taken in a limiting sense.

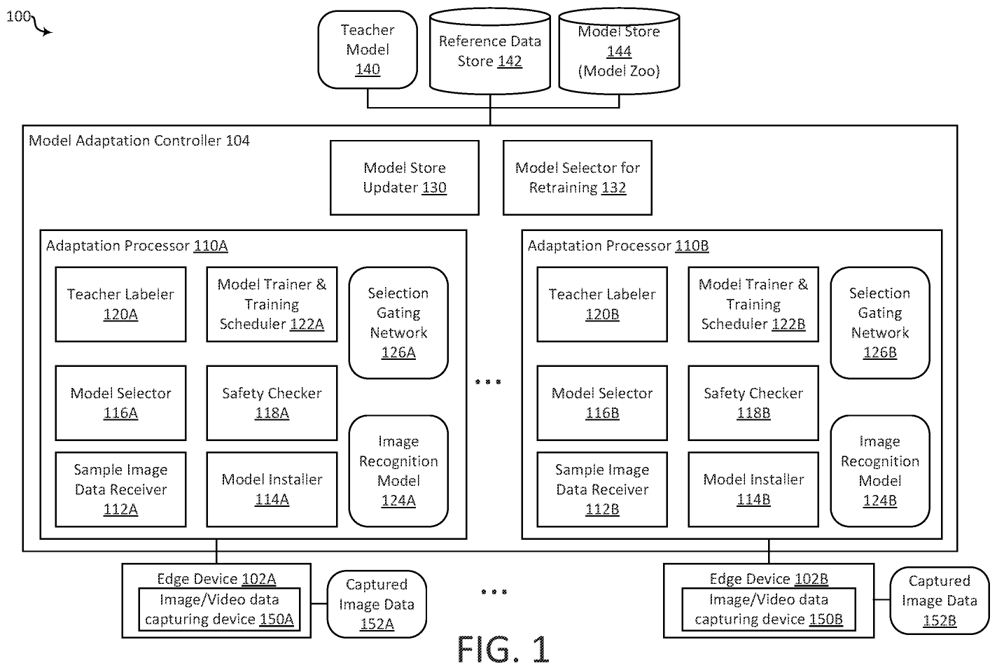

FIG. 1 illustrates an overview of an example system for reusing and retraining data recognition model in accordance with aspects of the present disclosure. A system 100 includes edge devices 102A and 102B and model adaptation controller 104. The model adaptation controller 104 includes adaptation processors 110A and 110B, model store updater 130, and model selector for retraining 132. The model adaptation controller 104 connects with teacher model 140, reference data store 142, and model store 144 (e.g., a “model zoo”). In examples, the system 100 may be a part of the 5G (e.g., 4G, 6G, and the like) telecommunication network. For example, the respective edge devices 102A and 102B may communicate with the model adaptation controller 104 via a cellular network, while the model adaptation controller 104 may be a part of an edge server in a radio access network or in a core network and/or in a cloud associated with the 5G telecommunication network.

The edge devices 102A and 104A may respectively include one or more image and/or video data capturing devices 150A and 150B (e.g., video cameras) for capturing scenes. The edge device 102A captures image or video data (e.g., captured image data 152A and 152B) and transmits the captured image data 152A and 152B to the adaptation processor 110A. Similarly, the edge device 102B captures and transmits image and/or video data to the adaptation processor 110B.

In examples, an adaptation processor 110A includes sample image data receiver 112A, model installer 114A, model selector 116A, safety checker 118A, teacher labeler 120A, and model trainer & training scheduler 122A. The adaptation processor 110A further includes image recognition model 124A and selection gating network 126A. The model adaptation controller 104 may include a plurality of adaptation processors 110A and 110B. Each of the adaptation processor 110A and 110B may include substantially identical parts as detailed above for the adaptation processor 110A.

The image recognition models 124A and 124B performs inferencing to extract a feature based on captured image data. The adaptation processor 110A and 110B adaptively updates and installs the image recognition models 124A and 124B by reusing models stored in the model store 144 and retraining the one or more models using reference data (e.g., ground truth data) stored in the reference data store 142.

In examples, the edge device 102A captures image/video data using the image and/or video data capturing device 150A and transmits image data (e.g., a frame of video data) to the sample image data receiver 112A of the adaptation processor 110A. The sample image data receiver 112A receives the image data and sends the image data to the model selector 116A for reusing and to the teacher labeler 120A for retraining the model.

In examples, the reuse of a model includes selecting a predetermined number of candidate models from the model store 144 (e.g., the model zoo), selecting a model based on relative accuracies, and installing/updating the image recognition model 124A in the adaptation processor 110A. In examples, the model selector 116A receives the image data from the sample image data receiver 112A. The model selector 116A selects one or more candidate models from the model store 144 using the selection gating network 126A. The selection gating network 126 includes a gating network for selecting a candidate model based on the received image data. In aspects, the gating network includes one or more gating for identify a model that is the most suitable for use. The gating network receives image data as an input and outputs a candidate model as the most likely fit (e.g., based on a likelihood of matching) to the image data. The model selector 116A selects a predetermined number of candidate models for further selections by the safety checker 118A.

The safety checker 118A checks and selects a candidate model that has been selected by the model selector 116A for reuse. In particular, the safety checker 118A tests the accuracy of these top K candidate models, along with the image recognition model 124A (e.g., the currently used model for inference) associated with the edge device and the last model retrained. The testing includes a use of the sampled frames and their “ground truth” label as labeled by the teacher model 140. The teacher model 140 is more accurate and more expensive use of resources than using the image recognition model 124A. In aspects, the teacher model 140 is trained by using one or more prelabeled sample image as training data. Finally, among candidate models including these selected models (top-K from the model zoo (e.g., the model store 114), the currently used model (e.g., the image recognition model 124A), and the last retrained model stored in the model store 114), the safety checker 118 selects the one image recognition model with the highest empirical accuracy on the labeled images. The model installer 114A installs the candidate model in the image recognition model 124A for use in recognizing image data. In aspects, this online model selection process may be fully automated.

The retraining of a model includes generating a reference label associated with the captured data, rescheduling the retraining of the image recognition model 124A, and retraining the image recognition model 124A. In examples, the teacher labeler 120A receives the image data and determines a label of the image data using the teacher model 140. The label is a reference label with a sufficient degree of accuracy for use as reference label associated with the image data. The teacher labeler 120A stores the reference label in the reference data store 142. The model trainer and training scheduler 122A schedules a time for retraining the image recognition model 124A. The model selector for retraining 132 selects one of image recognition models in the model store 144 for retraining. The model trainer & training schedule 122A retrains the image recognition model using the reference image data stored in the reference data store 142. The reference data store 142 stores pairs of reference image data labeled with a reference label. The model trainer & training scheduler 122A stores the retrained image recognition model in the model store 144.

In examples, the model store 144 may be pruned by removing one or more trained models from the model store 144. In aspects, the pruning includes counting a number of occasions of selecting the selected image recognition model. The pruning further removes, based on the number of occasions of selecting the selected image recognition model being less than a threshold, the selected image recognition model from the model store. The pruning of the model store 144 enables maintaining a size of the model store 144 at a sufficient size for balancing between maintaining a reasonable number of models for reuse while preventing the model store 144 from becoming too large for efficiently identifying models for reuse or for retraining.

As will be appreciated, the various methods, devices, applications, features, etc., described with respect to FIG. 1 are not intended to limit the system 100 to being performed by the particular applications and features described. Accordingly, additional controller configurations may be used to practice the methods and systems herein and/or features and applications described may be excluded without departing from the methods and systems disclosed herein.

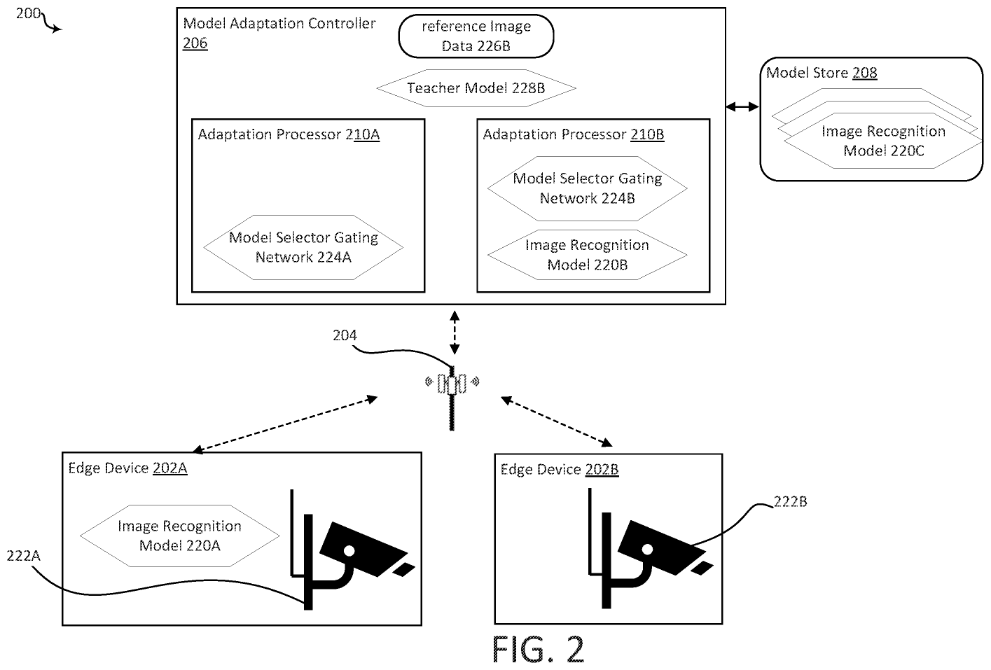

FIG. 2 illustrates an overview of an example system reusing and retraining image recognition model for processing captured video data in accordance with aspects of the present disclosure. In particular, the figure illustrates capturing and transmitting image/video data in edge devices, an antenna 204, and the model adaptation controller 206 adapts an image recognition model based on reusing and retraining. System 200 includes edge devices 202A and 202B and a model adaptation controller 206. In examples the edge device 202A captures image data (e.g., a frame of video data) using a camera 222A and transmits the image data via an antenna 204A using a telecom wireless network (e.g., the 5G telecommunication network).

In examples, the edge device 202A includes an image recognition model 220A for processing image recognition in the edge device 202A. The image recognition model 220A may be used to determine a feature associated with the captured image data. The edge device 202A transmits the determined feature and/or the captured image data to the adaptation processor 110A The transmitted image data may be used by the adaptation processor 110A for further processing associated with reuse and retraining of models.

Additionally, or alternatively, the edge device 202B does not include the image recognition model 220A; the adaptation processor 110B includes the image recognition model 220B. The edge device 202B transmits the captured image data to the adaptation processor 110B of the model adaptation controller 206 for determining a feature associated with the captured image data and for reuse and/or retraining model models.

The model adaptation controller 206 includes the adaptation processors 210A and 210B, reference image data 226B and teacher model 228B. The model adaptation controller 206 may connect to a model store 208. The model store 208 includes one or more image recognition models 220C for reuse and for retraining. The teacher model 228B represents an image recognition that is trained using the reference image data 226B.

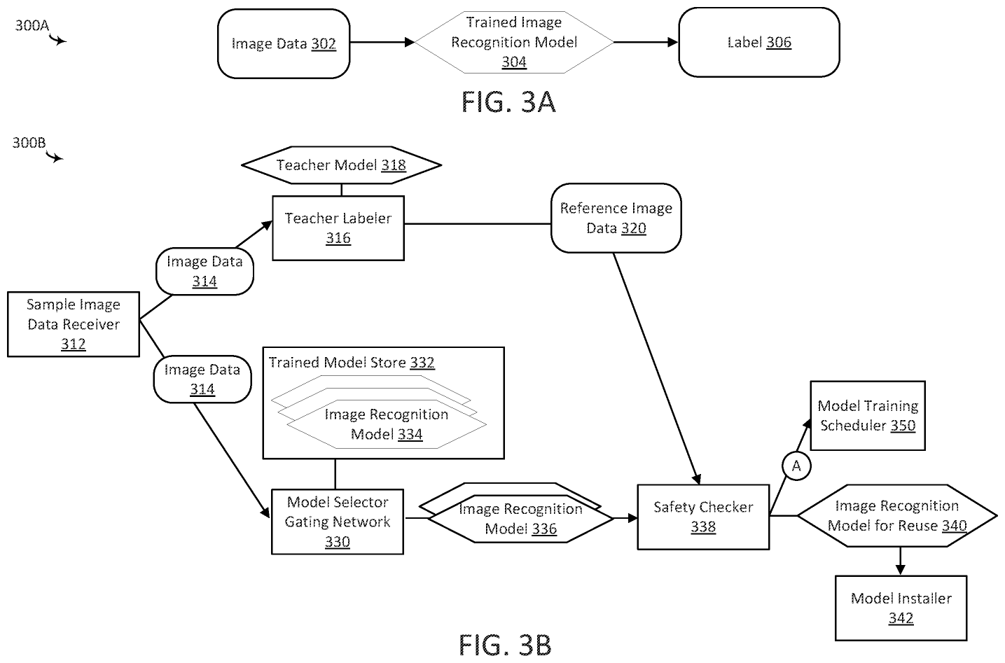

FIG. 3A illustrates an example data associated with labeling image data in accordance with aspects of the present disclosure. A data transformation 300A illustrates using image data 302 (e.g., captured sample image data) as an input to trained image recognition model 304. The trained image recognition model 304 predicts a label 306 (e.g., a feature) associated with the image data 302 as an output.

FIG. 3B illustrates an example system for reusing an image recognition model in accordance with aspects of the present disclosure. A system 300B uses image data 314 received from an edge device for reusing and retaining image recognition models. In examples, sample image data receiver 312 receives sample image data captured by one or more edge devices. The sample image data receiver 312 may receive sample image data periodically based on a predetermined time interval. Additionally, or alternatively, the sample image data receiver 312 may receive sample image data when content of captured image data changes more than a predetermined threshold.

Teacher labeler 316 receives the image data 314 from the sample image data receiver 312. The teacher labeler 316 generates a reference image data 320 associated with the image data 314 using a teacher model 318. The teacher model 318 is an image recognition model that has been trained more extensively with more training data than the image recognition models 334 stored in model store 332. In aspects, the image recognition models 334 represent light-weight models for which a level of accuracy in correctly labeling image data may vary. In contrast, the teacher labeler 316 labels the image data 314 with labels in a sufficiently high level of accuracy. Accordingly, the resulting labels may be used as reference labels to check a level of accuracy of the ranked image recognition models 336 determining a label associated with the image data 314.

The model selector gating network 330 uses the image data 314 to select one or more image recognition models 334 from the model store 332. In aspects, the model selector gating network 330 ranks the image recognition models in the model store 332 according to a level of confidence of predicting a label associated with the image data 314. The model selector gating network 330 selects a predetermined number of image recognition models from the highest level of confidence for further checking validity of ranked image recognition models 336. The safety checker 338 determines labels associated with the image data 314 using the ranked image recognition models. The safety checker 338 selects an image recognition for reuse 340 by comparing the labels with the reference image data 320. The safety checker 338 selects the image recognition model with a corresponding label that is the closest to the reference label of the reference image data 320 as the image recognition model for reuse 340. The model installer 342 installs the image recognition model for reuse 340.

The safety checker 338 further selects an image recognition model in the ranked image recognition model 336 for retraining by sending the selected image recognition model to the model training schedule 350. The path ‘A’ indicates a path for retraining the image recognition model.

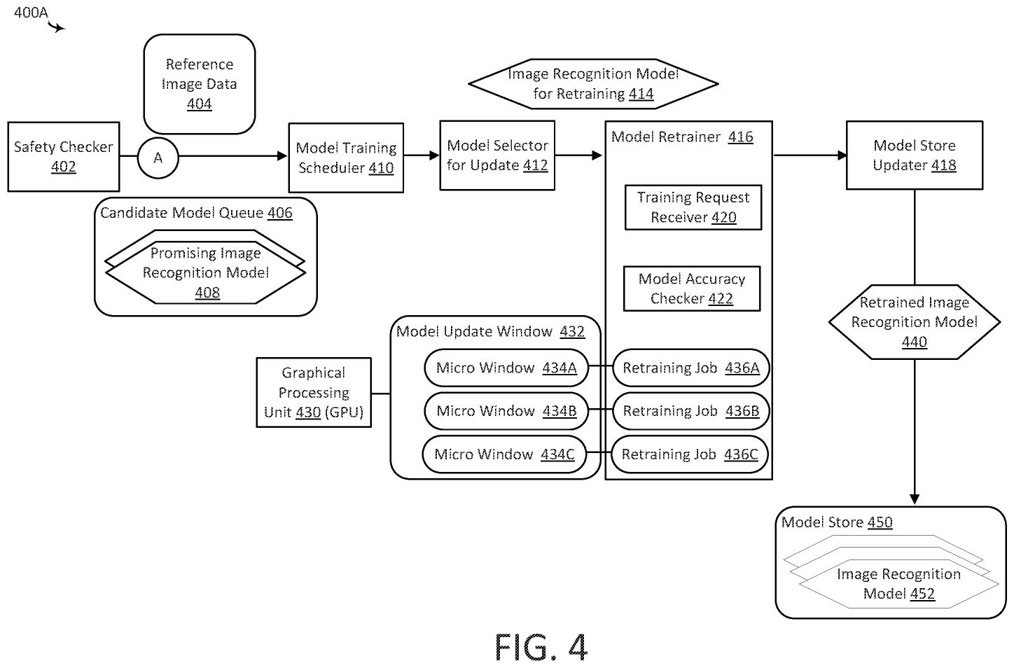

FIG. 4 illustrates an example system for retraining an image recognition model in accordance with aspects of the present disclosure. A safety checker 402 (e.g., the safety checker 338 as shown in FIG. 3) inserts an image recognition model into a candidate model queue 406. The candidate model queue 406 includes one or more promising image recognition models 408 for retraining. In examples, a recently trained model is considered promising if the safety checker finds this retrained model's accuracy is a higher than the rest of the candidate models (the top-K experts selected by gating network and edge device's current model).

Model training scheduler 410 receives the candidate model queue 406 and reference image data 404 (e.g., the reference image data 320 as shown in FIG. 3) and schedules retaining. Model selector for update 412 selects an image recognition model for retraining 414 from the promising image recognition models 408 in the candidate model queue 406.

Model retrainer 416 retrains the image recognition model for retraining 414. The model retrainer 416 includes training request receiver 420 and model accuracy checker 422. In examples, the model retrainer 416 retrains the image recognition for retraining 414 using the reference image data 404, which is based on sample image data received from an edge device. In some examples, a same graphical processing unit (GPU) is used for respective processing associated with inferencing captured image data, selecting a reusing an image recognition model, and retraining of one or more image recognition models.

In examples, the model retrainer 416 uses a micro-window of processing for retraining an image recognition model. The micro-window corresponds to a cycle of iterative retraining of an image recognition model. After an iteration of retraining, the model accuracy checker 422 determines an improvement of a level of accuracy in labeling image data. The iterative processing of retraining stops when the level of accuracy reaches a predetermined level of accuracy. At the beginning of an update window of a predetermined size, the training request receiver 420 receives a set of training requests for retraining jobs 436A, 436B, and 436C. The retraining job 436A corresponds to a micro window 434A, 434B, and 434C in the model update window 432. A graphics processing unit 430 (GPU) executes the iterative retraining based on the micro windows 434A, 434B, and 434C. A training request corresponds to a set of image data with the reference label. In a micro window, the model accuracy checker 422 evaluates how much its accuracy improves between before and after a micro window.

Model store updater 418 receives and stores a retrained image recognition model 440 in model store 450 (“a model zoo”). The model store 450 include one or more image recognition model 452.

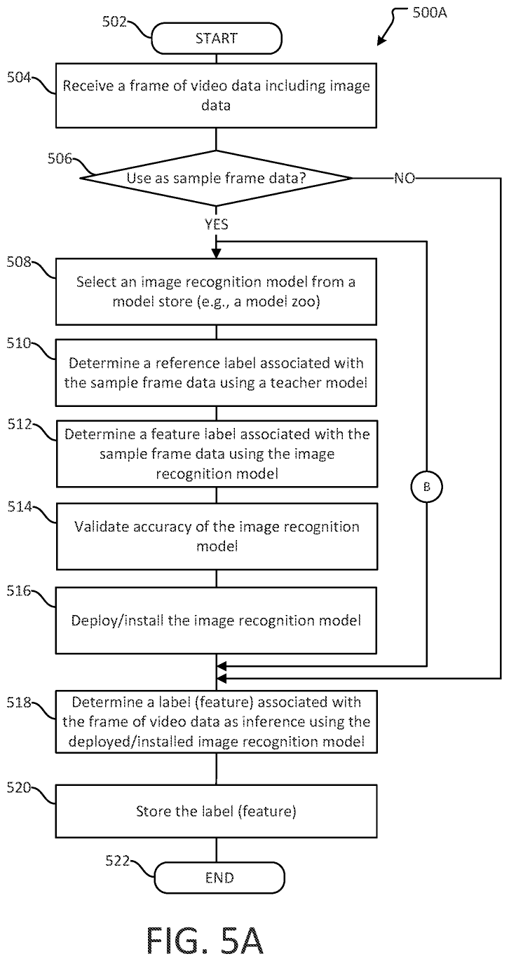

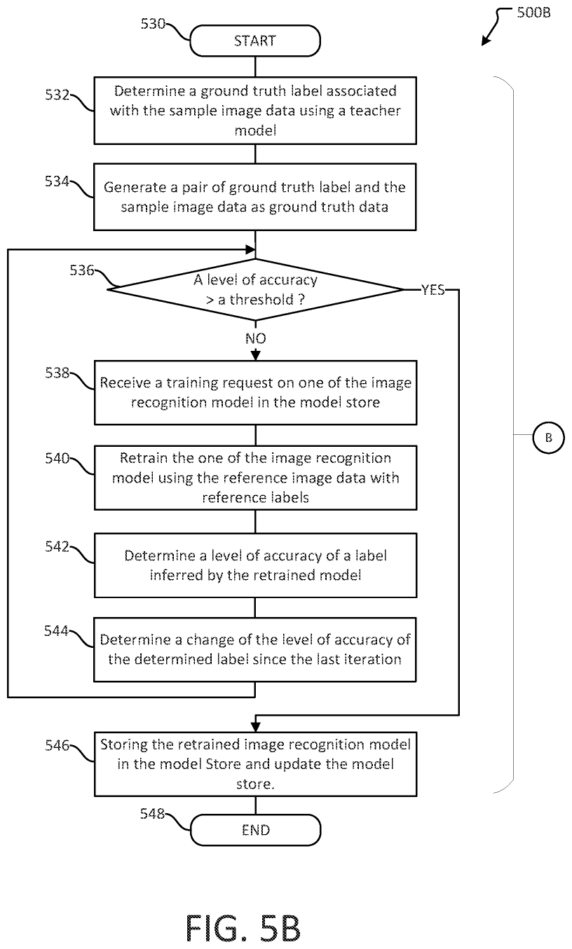

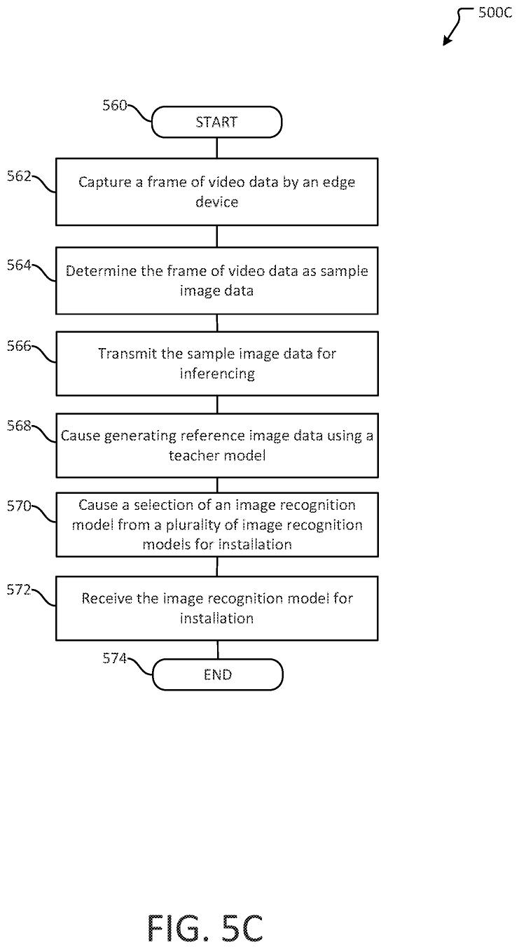

FIGS. 5A-C illustrate examples of methods for reusing and retraining an image recognition model in accordance with aspects of the present disclosure. A general order of the operations for the method 500A for reusing and retraining an image processing model in FIG. 5A. Generally, the method 500A begins with start operation 502. The method 500A may include more or fewer steps or may arrange the order of the steps differently than those shown in FIG. 5A. The method 500A can be executed as a set of computer-executable instructions executed by a computer system and encoded or stored on a computer readable medium. Further, the method 500A can be performed by gates or circuits associated with a processor, an ASIC, an FPGA, a SOC or other hardware device. Hereinafter, the method 500A shall be explained with reference to the systems, components, devices, modules, software, data structures, data characteristic representations, signaling diagrams, methods, etc., described in conjunction with FIGS. 1, 2, 3A-3B, 4, 5B-5C, 6, and 7A-7B.

Following start operation 502, the method 500A begins with receive operation 504, in which a frame of video data including image data is received. In aspects, the method 500A repeats when an image/video data capturing device of an edge device (e.g., the image/video data capturing device 150A of the edge device 102A as shown in FIG. 1) captures a frame of video data including image data.

At decision operation 506, a decision is made whether to use the frame of video data as sample image data. In examples, a frame of video data is used as sample image data on a periodic basis after a predetermined time lapses. In other examples, a frame of video data is used as a sample image data when content of the frame of video data indicates a change of scenery or a substantial change in content from one frame (or set of frames) to a next frame (or set of frames).

When the decision operation 506 decides to use the frame of video data as sample image data, the step proceeds to a select operation 508 and a path ‘B.’ At the select operation 508, an image recognition model is selected from a model store (e.g., a model zoo). In aspects, the select operation 508 selects a plurality of image recognition models based on a level of confidence in recognizing the sample image data. In some aspects, the select operation ranks the selected image recognition models according to levels of confidence. In examples, the select operation 508 uses a selection model including a gating network to identify one or more image recognition models that are associated with the sample image data.

At determine operation 510, a reference label associated with the sample image data is determined by using a teacher model. In aspects, the teacher model used in the model adaptation controller (e.g., the teacher model 228B and the model adaptation controller 206 as shown in FIG. 2) is more extensively trained to perform inferencing more accurately than the respective image recognition data models. In contrast, the respective image recognition data models (e.g., the image recognition models 220A, 220B, and 220C as shown in FIG. 2) are less extensively trained and have a smaller memory footprint than the teacher model. In this way, the image recognition models are able to satisfy constraints associated with memory and computing resources imposed on the edge devices (e.g., the edge device 202A as shown in FIG. 2) for installation and execution. As such, the reference label inferenced by the teacher model in a server or in the cloud represents the sample image data with a higher confidence level than feature labels determined by respective image recognition models on an edge device. By virtue of inferencing the sample data by using the teacher model, the reference label represents a ground truth label associated with the sample image data.

At determine operation 512, a feature label associated with the sample image data using the image recognition model as selected in the select operation 508. In aspects, the image recognition model represents a candidate model for reuse in inferencing image data.

At validate operation 514, an accuracy of the image recognition model is validated by comparing labels determined by the respective image recognition models against a reference label associated with the reference image data based on the sample image data. The validate operation 514 selects an image recognition model based on an accuracy of the image recognition model in labeling the sample image data as compared with the reference image data for reuse.

At install operation 516, the selected image recognition model for reuse is installed. The installed image recognition model is subsequently used for determining inferences of frames of video data that have been captured by an edge device.

Steps taken along the path ‘13’ are in FIG. 5B. In particular, the path ‘13’ includes steps that relate to retraining an image recognition model. After retraining the image recognition model, the retrained image recognition model is placed in the model store for future use. In some aspects, the disclosure may install the retrained image recognition model for inferencing a feature of frames of video data captured by the edge device.

At determine operation 518, a label (e.g., a feature) associated with the frame of video data is determined as inference by using the image recognition model that has been reused and installed. When the decision operation 506 decides not to use the frame including image data as sample image data, the step proceeds to the determine operation 518.

At store operation 520, the determined label associated with the frame of video data (e.g., a feature inferred from the image data) is stored. In aspects, the store operation 520 stores the determined label in the cloud. The cloud may retrieve the determined label for further processing of the determined label. Examples of further processing may include but is not limited to generating an alert based on the determined label associated with the captured image data. Further examples may include processing by a cloud application that tracks objects. The method 500A ends with the end operation 522. In aspects, the method 500A may repeat with the receive operation 504 when an image/video data capturing device of the edge server captures a next frame of video data including image data.

As should be appreciated, operations 502-522 are described for purposes of illustrating the present methods and systems and are not intended to limit the disclosure to a particular sequence of steps, e.g., steps may be performed in different order, additional steps may be performed, and disclosed steps may be excluded without departing from the present disclosure.

FIG. 5B illustrates an example of a method for retraining image recognition models in accordance with aspects of the claimed subject matter. A general order of the operations for the method 500B is shown in FIG. 5B. Generally, the method 500B begins with start operation 530. The method 500B may include more or fewer steps or may arrange the order of the steps differently than those shown in FIG. 5B. The method 500B can be executed as a set of computer-executable instructions executed by a computer system and encoded or stored on a computer readable medium. Further, the method 500B can be performed by gates or circuits associated with a processor, an ASIC, an FPGA, a SOC or other hardware device. Hereinafter, the method 500B shall be explained with reference to the systems, components, devices, modules, software, data structures, data characteristic representations, signaling diagrams, methods, etc., described in conjunction with FIGS. 1, 2, 3A-3B, 4, 5A, 5C, 6, and 7A-7B.

The method 500B corresponds to the path ‘13’ as shown in FIG. 5A. Following start operation 530, the method 500B begins with determine operation 532, in which a reference label associated with the sample image data is determined using a teacher model as a ground truth label.

At generating operation 534, a pair of a reference label and the sample image data (e.g., reference image data) is generated and stored as reference image data in a reference data store (e.g., the reference data store 142 as shown in FIG. 1) In examples, the reference image data that is labeled with a reference label is used for retraining image recognition models.

At decision operation 536, whether a level of accuracy of labeling the sample image data is higher than a predetermined threshold is decided. In aspects, the level of accuracy may be determined based on a magnitude of difference by comparing a label inferred from the sample image data by an image recognition model and the reference label. For example, the image recognition model is accurate when the inferred label is identical to the reference label. When the level of accuracy is not higher than the predetermined threshold, the method proceeds to receive operation 538. At the receive operation 538, a training (e.g., retraining) request on one of the image recognition models in the model store is received.

At retrain operation 540, the one of the image recognition models is retrained. The retraining of the models uses the reference image data with a corresponding reference label. In aspects, more than one image recognition models may be retrained concurrently by allocating micro windows of execution cycles in the graphical processing unit (GPU) for executing iterations of retraining processes.

At determine a level of accuracy operation 542, a level of accuracy of a label inferred by the retrained model is determined. In examples, the level of accuracy corresponds to a difference in value between a label inferred from the sample image data by the retrained image recognition model and the reference label.

At determine a change of the level of accuracy operation 544, a change of the level of accuracy of inferring a label since the previous iteration is determined. The process proceeds to the decision operation 536 for further processing. In aspects, the change of the level of accuracy decreases over iterations of retraining. The step proceeds to the decision operation 536.

When the level of accuracy is higher than the predetermined threshold in the decision operation 536, the step proceeds to store and update operation 546. At the store and update operation 546, the retrained image recognition model is stored in a model store and updates the model store for a reuse in the future. In aspects, the storing operation 546 does not store the retrained image recognition model in the model store when the level of accuracy in inferring a label based on image data is below the predetermined threshold. The method 500B ends in the end operation 548.

As should be appreciated, operations 530-548 are described for purposes of illustrating the present methods and systems and are not intended to limit the disclosure to a particular sequence of steps, e.g., steps may be performed in different order, additional steps may be performed, and disclosed steps may be excluded without departing from the present disclosure.

FIG. 5C illustrates an example of a method for retraining image recognition models in accordance with aspects of the claimed subject matter. A general order of the operations for the method 500C is shown in FIG. 5C. Generally, the method 500C begins with start operation 560. The method 500C may include more or fewer steps or may arrange the order of the steps differently than those shown in FIG. 5C. The method 500C can be executed as a set of computer-executable instructions executed by a computer system and encoded or stored on a computer readable medium. Further, the method 500C can be performed by gates or circuits associated with a processor, an ASIC, an FPGA, a SOC or other hardware device. Hereinafter, the method 500C shall be explained with reference to the systems, components, devices, modules, software, data structures, data characteristic representations, signaling diagrams, methods, etc., described in conjunction with FIGS. 1, 2, 3A-3B, 4, 5A, 5B, 6, and 7A-7B.

Following start operation 560, the method 500C begins with capture operation 562, in which a frame of video data is captured by an edge device (e.g., the edge device 102A including the image and/or video data capturing device 105A as shown in FIG. 1).

At determine operation 564, the frame of video data is determined as sample image data. In examples, the frame of video data is determined as sample image data based on a time lapse, in a periodic basis. In some other examples, the frame of video data is selected as sample image data when a change of scenery takes place in the frame of video data.

At transmit operation 566, the sample image data (i.e., the determined frame of video data) is transmitted over a network to a model adaptation controller (e.g., the model adaptation controller 104 as shown in FIG. 1). The network may include a wireless network. The wireless network may be a part of the 5G telecommunication network or other types of wireless communication network. In examples, the model adaptation controller operates in an edge server. In some examples, the model adaptation controller operates in a cloud.

At cause generating reference image data operation 568, the transmit operation 566 causes generating reference image data using a teacher model in the model adaptation controller. In aspects, the teacher model generates a reference label by inferencing and generates the reference image data. The reference image data may include the sample image data and the reference label.

At cause selection operation 570, the transmit operation 566 causes selecting an image recognition model from a plurality of image recognition model for installation. In aspects, the image recognition model may be selected for reuse. The selecting of the image recognition model may be performed by the model adaptation controller. Additionally, or alternatively, the cause selection operation 570 causes retraining of the image recognition model.

At receive operation 572, the image recognition model is received from the model adaptive controller for installation. In aspects, the image recognition model is received by the edge device for installation. In some other aspects, the image recognition model is received for installation in the image and/or video data capturing device. The method 500C ends with end operation 574.

As should be appreciated, operations 560-574 are described for purposes of illustrating the present methods and systems and are not intended to limit the disclosure to a particular sequence of steps, e.g., steps may be performed in different order, additional steps may be performed, and disclosed steps may be excluded without departing from the present disclosure.

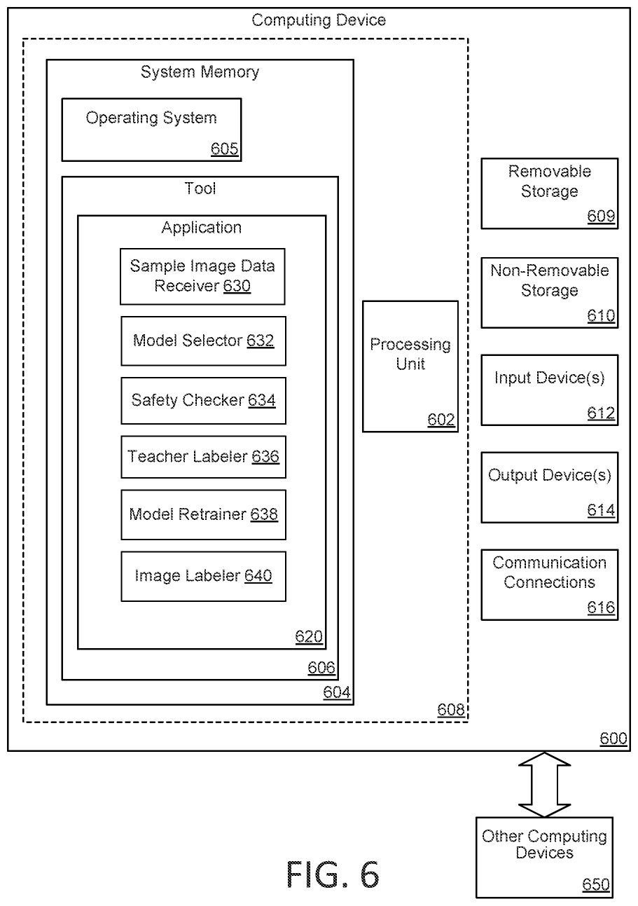

FIG. 6 is a block diagram illustrating physical components (e.g., hardware) of a computing device 600 with which aspects of the disclosure may be practiced. The computing device components described below may be suitable for the computing devices described above. In a basic configuration, the computing device 600 may include at least one processing unit 602 and a system memory 604. Depending on the configuration and type of computing device, the system memory 604 may comprise, but is not limited to, volatile storage (e.g., random access memory), non-volatile storage (e.g., read-only memory), flash memory, or any combination of such memories. The system memory 604 may include an operating system 605 and one or more program tools 606 suitable for performing the various aspects disclosed herein such. The operating system 605, for example, may be suitable for controlling the operation of the computing device 600. Furthermore, aspects of the disclosure may be practiced in conjunction with a graphics library, other operating systems, or any other application program and is not limited to any particular application or system. This basic configuration is illustrated in FIG. 6 by those components within a dashed line 608. The computing device 600 may have additional features or functionality. For example, the computing device 600 may also include additional data storage devices (removable and/or non-removable) such as, for example, magnetic disks, optical disks, or tape. Such additional storage is illustrated in FIG. 6 by a removable storage device 609 and a non-removable storage device 610.

As stated above, a number of program tools and data files may be stored in the system memory 604. While executing on the at least one processing unit 602, the program tools 606 (e.g., an application 620) may perform processes including, but not limited to, the aspects, as described herein. The application 620 includes sample image data receiver 630, model selector 632, safety checker 634, teacher labeler 636, model retrainer 638, and image labeler 640 as described in more details in FIG. 1. Other program tools that may be used in accordance with aspects of the present disclosure may include electronic mail and contacts applications, word processing applications, spreadsheet applications, database applications, slide presentation applications, drawing or computer-aided application programs, etc.

Furthermore, aspects of the disclosure may be practiced in an electrical circuit comprising discrete electronic elements, packaged or integrated electronic chips containing logic gates, a circuit utilizing a microprocessor, or on a single chip containing electronic elements or microprocessors. For example, aspects of the disclosure may be practiced via a system-on-a-chip (SOC) where each or many of the components illustrated in FIG. 6 may be integrated onto a single integrated circuit. Such an SOC device may include one or more processing units, graphics units, communications units, system virtualization units, and various application functionality all of which are integrated (or “burned”) onto the chip substrate as a single integrated circuit. When operating via an SOC, the functionality, described herein, with respect to the capability of client to switch protocols may be operated via application-specific logic integrated with other components of the computing device 600 on the single integrated circuit (chip). Aspects of the disclosure may also be practiced using other technologies capable of performing logical operations such as, for example, AND, OR, and NOT, including but not limited to mechanical, optical, fluidic, and quantum technologies. In addition, aspects of the disclosure may be practiced within a general-purpose computer or in any other circuits or systems.

The computing device 600 may also have one or more input device(s) 612, such as a keyboard, a mouse, a pen, a sound or voice input device, a touch or swipe input device, etc. The output device(s) 614 such as a display, speakers, a printer, etc. may also be included. The aforementioned devices are examples and others may be used. The computing device 600 may include one or more communication connections 616 allowing communications with other computing devices 650. Examples of the communication connections 616 include, but are not limited to, radio frequency (RF) transmitter, receiver, and/or transceiver circuitry; universal serial bus (USB), parallel, and/or serial ports.

The term computer readable media as used herein may include computer storage media. Computer storage media may include volatile and nonvolatile, removable and non-removable media implemented in any method or technology for storage of information, such as computer readable instructions, data structures, or program tools. The system memory 604, the removable storage device 609, and the non-removable storage device 610 are all computer storage media examples (e.g., memory storage). Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 600. Any such computer storage media may be part of the computing device 600. Computer storage media does not include a carrier wave or other propagated or modulated data signal.

Communication media may be embodied by computer readable instructions, data structures, program tools, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

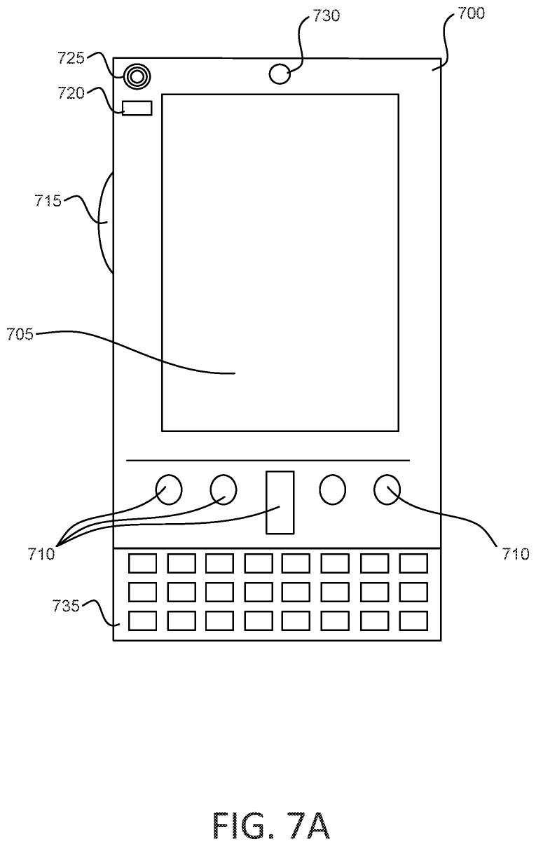

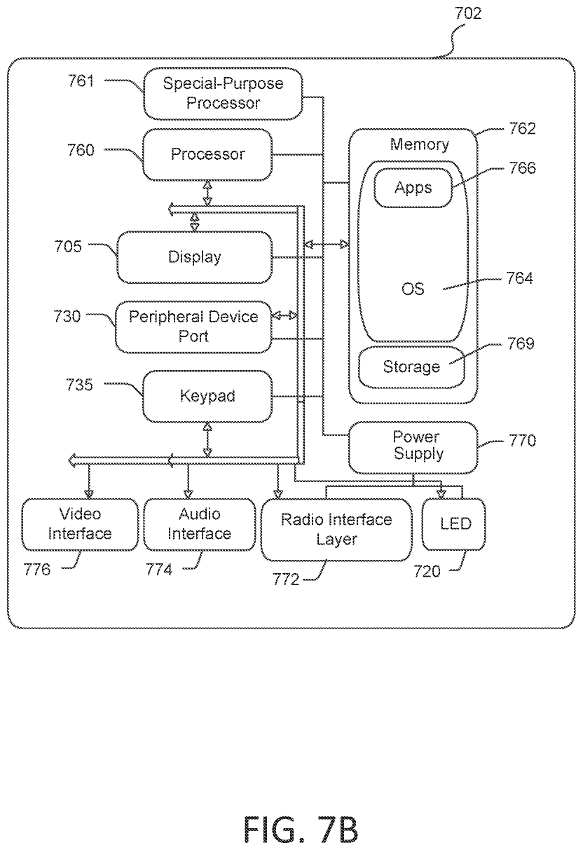

FIGS. 7A and 7B illustrate a computing device or mobile computing device 700, for example, a mobile telephone, a smart phone, wearable computer (such as a smart watch), a tablet computer, a laptop computer, and the like, with which aspects of the disclosure may be practiced. In some aspects, the client utilized by a user (e.g., the system 100 in FIG. 1) may be a mobile computing device. With reference to FIG. 7A, one aspect of a mobile computing device 700 for implementing the aspects is illustrated. In a basic configuration, the mobile computing device 700 is a handheld computer having both input elements and output elements. The mobile computing device 700 typically includes a display 705 and one or more input buttons 710 that allow the user to enter information into the mobile computing device 700. The display 705 of the mobile computing device 700 may also function as an input device (e.g., a touch screen display). If included as an optional input element, a side input element 715 allows further user input. The side input element 715 may be a rotary switch, a button, or any other type of manual input element. In alternative aspects, mobile computing device 700 may incorporate more or less input elements. For example, the display 705 may not be a touch screen in some aspects. In yet another alternative aspect, the mobile computing device 700 is a portable phone system, such as a cellular phone. The mobile computing device 700 may also include an optional keypad 735. Optional keypad 735 may be a physical keypad or a “soft” keypad generated on the touch screen display. In various aspects, the output elements include the display 705 for showing a graphical user interface (GUI), a visual indicator 720 (e.g., a light emitting diode), and/or an audio transducer 725 (e.g., a speaker). In some aspects, the mobile computing device 700 incorporates a vibration transducer for providing the user with tactile feedback. In yet another aspect, the mobile computing device 700 incorporates input and/or output ports, such as an audio input (e.g., a microphone jack), an audio output (e.g., a headphone jack), and a video output (e.g., a HDMI port) for sending signals to or receiving signals from an external device.

FIG. 7B is a block diagram illustrating the architecture of one aspect of computing device, a server (e.g., the model adaptation controller 104, as shown in FIG. 1), a mobile computing device, etc. That is, the mobile computing device 700 can incorporate a system 702 (e.g., a system architecture) to implement some aspects. The system 702 can implemented as a “smart phone” capable of running one or more applications (e.g., browser, e-mail, calendaring, contact managers, messaging clients, games, and media clients/players). In some aspects, the system 702 is integrated as a computing device, such as an integrated digital assistant (PDA) and wireless phone.

One or more application programs 766 may be loaded into the memory 762 and run on or in association with the operating system 764. Examples of the application programs include phone dialer programs, e-mail programs, information management (PIM) programs, word processing programs, spreadsheet programs, internet browser programs, messaging programs, and so forth. The system 702 also includes a non-volatile storage area 768 within the memory 762. The non-volatile storage area 768 may be used to store persistent information that should not be lost if the system 702 is powered down. The application programs 766 may use and store information in the non-volatile storage area 768, such as e-mail or other messages used by an e-mail application, and the like. A synchronization application (not shown) also resides on the system 702 and is programmed to interact with a corresponding synchronization application resident on a host computer to keep the information stored in the non-volatile storage area 868 synchronized with corresponding information stored at the host computer. As should be appreciated, other applications may be loaded into the memory 762 and run on the mobile computing device 700 described herein.

The system 702 has a power supply 770, which may be implemented as one or more batteries. The power supply 770 might further include an external power source, such as an AC adapter or a powered docking cradle that supplements or recharges the batteries.

The system 702 may also include a radio interface layer 772 that performs the function of transmitting and receiving radio frequency communications. The radio interface layer 772 facilitates wireless connectivity between the system 702 and the “outside world” via a communications carrier or service provider. Transmissions to and from the radio interface layer 772 are conducted under control of the operating system 764. In other words, communications received by the radio interface layer 772 may be disseminated to the application programs 766 via the operating system 764, and vice versa.

The visual indicator 720 (e.g., LED) may be used to provide visual notifications, and/or an audio interface 774 may be used for producing audible notifications via the audio transducer 725. In the illustrated configuration, the visual indicator 720 is a light emitting diode (LED) and the audio transducer 725 is a speaker. These devices may be directly coupled to the power supply 770 so that when activated, they remain on for a duration dictated by the notification mechanism even though the processor 760 and other components might shut down for conserving battery power. The LED may be programmed to remain on indefinitely until the user takes action to indicate the powered-on status of the device. The audio interface 774 is used to provide audible signals to and receive audible signals from the user. For example, in addition to being coupled to the audio transducer 725, the audio interface 774 may also be coupled to a microphone to receive audible input, such as to facilitate a telephone conversation. In accordance with aspects of the present disclosure, the microphone may also serve as an audio sensor to facilitate control of notifications, as will be described below. The system 702 may further include a video interface 776 that enables an operation of devices connected to a peripheral device port 730 to record still images, video stream, and the like.

A mobile computing device 700 implementing the system 702 may have additional features or functionality. For example, the mobile computing device 700 may also include additional data storage devices (removable and/or non-removable) such as, magnetic disks, optical disks, or tape. Such additional storage is illustrated in FIG. 7B by the non-volatile storage area 768.

Data/information generated or captured by the mobile computing device 700 and stored via the system 702 may be stored locally on the mobile computing device 700, as described above, or the data may be stored on any number of storage media that may be accessed by the device via the radio interface layer 772 or via a wired connection between the mobile computing device 700 and a separate computing device associated with the mobile computing device 700, for example, a server computer in a distributed computing network, such as the Internet. As should be appreciated such data/information may be accessed via the mobile computing device 700 via the radio interface layer 772 or via a distributed computing network. Similarly, such data/information may be readily transferred between computing devices for storage and use according to well-known data/information transfer and storage means, including electronic mail and collaborative data/information sharing systems.

The description and illustration of one or more aspects provided in this application are not intended to limit or restrict the scope of the disclosure as claimed in any way. The claimed disclosure should not be construed as being limited to any aspect, for example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

The present disclosure relates to systems and methods for reusing and retraining models for video analytics according to at least the examples provided in the sections below. The method comprises receiving first image data; selecting, based on the first image data using a selection model, a first image recognition model from a plurality of trained image recognition models, wherein the selection model is associated with a gating network, wherein the gating network predicts the first image recognition model based on a likelihood of outputting image data matching with the first image data; determining a reference label associated with the first image data using a teacher model, wherein the reference label represents an inference of the first image data based on at least one prelabeled sample image, and wherein the teacher model generates the reference label by inferencing; determining a first feature label associated with the first image data using the first image recognition model; validating an accuracy of the first image recognition model in determining the first feature label based on a comparison between the reference label and the first feature label; responsive to the validating, adaptively installing the first image recognition model for reuse; receiving second image data; and processing the second image data for inferencing. The method further comprises receiving the first image data from an edge device associated with the 5G telecommunication network; selecting, based on the first image data using the selection model, a second image recognition model from the plurality of trained image recognition models; determining a third feature label associated with the first image data using the selected second image recognition model; determining variances of the first feature label and the third feature label from the reference label; and selecting, based on the variances of the first feature label and the third feature label from the reference label, the first image recognition model. The method further comprises, responsive to the selecting the first image recognition model, installing the first image recognition model for inferring captured image data; and determining, based on inferencing using the first image recognition model, a second feature label associated with the second image data. The method further comprises selecting, based on the first image data using the selection model, a set of image recognition models from the plurality of trained image recognition models; ranking, based on probability values associated with a likelihood of respective image recognition models accurately recognizing the first image data, the set of image recognition models; and selecting, based on the ranked set of image recognition models, the first image recognition model. The method further comprises receiving, by an edge server associated with the 5G telecommunication network, the first image data from an edge device via a wireless network of the 5G telecommunication network, wherein the edge device includes a camera for capturing the first image data. The teacher model determines the reference label based on the first image data, wherein the reference label is more accurate in inferencing the first image data than the first feature label in inferencing the first image data using the first image recognition model. The selection model selects one or more ranked image recognition models according to a fit between an image recognition model and the first image data. The method further comprises receiving, based on a predefined rule associated with a timing of capturing a frame of video data, the first image data. The method further comprises receiving, based on a change of scenery captured in a frame of video data, the first image data. The method further comprises counting a number of occasions of selecting the first image recognition model; and removing, based on the number of occasions of selecting the first image recognition model, the first image recognition model from the plurality of trained image recognition models. The method further comprises iteratively retraining the first image recognition model using the comparison between the reference label and the first feature label according to a predetermined level of accuracy; and adding the iteratively retrained first image recognition model to the plurality of trained image recognition models. The further comprises selecting a plurality of candidate models for retraining from the plurality of trained image recognition models; and iteratively processing the plurality of trained image recognition models until a change of a level of accuracy in labeling is less than a predetermined threshold. The method further comprises iteratively retraining the plurality of trained image recognition models by allocating a time period of using a processing resource for retraining the plurality of trained image recognition models.

Another aspect of the technology relates to a system for reusing and retraining image recognition models for inferencing data captured by an edge device. The system comprises a processor configured to execute a method comprising: receiving image data; determining, based on an inference using a first image recognition model, a first feature label associated with the image data, wherein the first image recognition model corresponds to an inference model; comparing the first feature label to a predetermined threshold associated with a reference label of a sample image generated by a teacher model, wherein the teacher model generates the reference label by inferencing; based on the comparing, determining a level of accuracy of inferencing the image data by the first image recognition model; based on the level of accuracy, selecting the first image recognition model for retraining; and updating, based on the retrained first image recognition model, a store of a plurality of trained image recognition models. The system further comprises the processor further configured to execute a method comprising: selecting, based on the first feature label by a selection model, a second image recognition model from a plurality of image recognition models for reuse; and installing the second image recognition model in the edge device associated with the 5G telecommunication network. The system further comprises the processor further configured to execute a method comprising: determining a second feature label associated with the image data using the second image recognition model; selecting, based on variances of the first feature label and the second feature label from the reference label, the second image recognition model for reuse; and performing inferencing subsequently received image input using the second image recognition model. The system further comprises the processor further configured to execute a method comprising: iteratively retraining the first image recognition model using a combination of the reference label and the image data while a level of accuracy in inferring the image data is below a predetermined level of accuracy; and updating the retrained first image recognition model in the plurality of trained image recognition models. The selection model selects, based on the image data, the second image recognition model from the plurality of image recognition models including a gating network, wherein the gating network predicts the first image recognition model based on a likelihood of outputting image data matching with the image data, and wherein the reference label is higher in accuracy in inferencing the image data than the first feature label associated with the first image recognition model.

In still further aspects, the technology relates to a device. The device comprises a processor configured to execute a method comprising: capturing a frame of video data, wherein the frame of video data includes image data; determining, based on predetermined conditions associated with sampling image data, the frame of video data including the image data as sample image data, wherein the predetermined conditions include the frame of video data representing a change of scenery or when a predetermined time lapses; transmitting the sample image data for inferencing; causing, based on the frame of video data, generating reference image data using a teacher model, wherein the reference image data includes a reference label, the reference label infers the frame of video data, and wherein the teacher model generates the reference label by inferencing; and causing, based on the reference image data, a selection of an image recognition model from a plurality of image recognition models for installation. The device represents an edge device of the 5G telecommunication network, and the processor further configured to execute a method comprising: causing retraining of the image recognition model in a cloud associated with the 5G telecommunication network using a least a part of a set of reference image data.

Any of the one or more above aspects in combination with any other of the one or more aspect. Any of the one or more aspects as described herein.

What is claimed is:

1. A method for reusing and retraining image recognition models, comprising:
receiving first image data;
selecting, based on the first image data using a selection model, a first image recognition model from a plurality of trained image recognition models, wherein the selection model is associated with a gating network, wherein the gating network predicts the first image recognition model based on a likelihood of outputting image data matching with the first image data;
determining a reference label associated with the first image data using a teacher model, wherein the reference label represents an inference of the first image data based on at least one prelabeled sample image, and wherein the teacher model generates the reference label by inferencing;
determining a first feature label associated with the first image data using the first image recognition model;
validating an accuracy of the first image recognition model in determining the first feature label based on a comparison between the reference label and the first feature label;
responsive to the validating, adaptively installing the first image recognition model for reuse;
receiving second image data; and
processing the second image data for inferencing.

2. The method of claim 1, further comprising:
receiving the first image data from an edge device associated with the 5G telecommunication network;
selecting, based on the first image data using the selection model, a second image recognition model from the plurality of trained image recognition models;
determining a third feature label associated with the first image data using the selected second image recognition model;
determining variances of the first feature label and the third feature label from the reference label; and
selecting, based on the variances of the first feature label and the third feature label from the reference label, the first image recognition model.

3. The method of claim 1, further comprising:
responsive to the selecting the first image recognition model, installing the first image recognition model for inferring captured image data; and
determining, based on inferencing using the first image recognition model, a second feature label associated with the second image data.

4. The method of claim 1, further comprising:
selecting, based on the first image data using the selection model, a set of image recognition models from the plurality of trained image recognition models;
ranking, based on probability values associated with a likelihood of respective image recognition models accurately recognizing the first image data, the set of image recognition models; and
selecting, based on the ranked set of image recognition models, the first image recognition model.

5. The method of claim 1, further comprising:
receiving, by an edge server associated with the 5G telecommunication network, the first image data from an edge device via a wireless network of the 5G telecommunication network, wherein the edge device includes a camera for capturing the first image data.

6. The method of claim 1, wherein the teacher model determines the reference label based on the first image data, wherein the reference label is more accurate in inferencing the first image data than the first feature label in inferencing the first image data using the first image recognition model.

7. The method of claim 1, wherein the selection model selects one or more ranked image recognition models according to a fit between an image recognition model and the first image data.

8. The method of claim 1, further comprising:
receiving, based on a predefined rule associated with a timing of capturing a frame of video data, the first image data.

9. The method of claim 1, further comprising:
receiving, based on a change of scenery captured in a frame of video data, the first image data.

10. The method of claim 1, further comprising:
counting a number of occasions of selecting the first image recognition model; and
removing, based on the number of occasions of selecting the first image recognition model, the first image recognition model from the plurality of trained image recognition models.

11. The method of claim 1, further comprising:
iteratively retraining the first image recognition model using the comparison between the reference label and the first feature label according to a predetermined level of accuracy; and
adding the iteratively retrained first image recognition model to the plurality of trained image recognition models.

12. The method of claim 11, further comprising:
selecting a plurality of candidate models for retraining from the plurality of trained image recognition models; and
iteratively processing the plurality of trained image recognition models until a change of a level of accuracy in labeling is less than a predetermined threshold.

13. The method of claim 11, further comprising:
iteratively retraining the plurality of trained image recognition models by allocating a time period of using a processing resource for retraining the plurality of trained image recognition models.

14. A system for reusing and retraining image recognition models for inferencing data captured by an edge device, the system comprises a processor configured to execute a method comprising:
receiving image data;
determining, based on an inference using a first image recognition model, a first feature label associated with the image data, wherein the first image recognition model corresponds to an inference model;
comparing the first feature label to a predetermined threshold associated with a reference label of a sample image generated by a teacher model, wherein the teacher model generates the reference label by inferencing;
based on the comparing, determining a level of accuracy of inferencing the image data by the first image recognition model;
based on the level of accuracy, selecting the first image recognition model for retraining; and
updating, based on the retrained first image recognition model, a store of a plurality of trained image recognition models.

15. The system of claim 14, the processor further configured to execute a method comprising:
selecting, based on the first feature label by a selection model, a second image recognition model from a plurality of image recognition models for reuse; and
installing the second image recognition model in the edge device associated with the 5G telecommunication network.

16. The system according to claim 15, the processor further configured to execute a method comprising:
determining a second feature label associated with the image data using the second image recognition model;
selecting, based on variances of the first feature label and the second feature label from the reference label, the second image recognition model for reuse; and
performing inferencing subsequently received image input using the second image recognition model.

17. The system according to claim 15, the processor further configured to execute a method comprising:
iteratively retraining the first image recognition model using a combination of the reference label and the image data while a level of accuracy in inferring the image data is below a predetermined level of accuracy; and
updating the retrained first image recognition model in the plurality of trained image recognition models.

18. The system according to claim 15,
wherein the selection model selects, based on the image data, the second image recognition model from the plurality of image recognition models including a gating network,
wherein the gating network predicts the first image recognition model based on a likelihood of outputting image data matching with the image data, and
wherein the reference label is higher in accuracy in inferencing the image data than the first feature label associated with the first image recognition model.

19. A device comprising a processor configured to execute a method comprising:
capturing a frame of video data, wherein the frame of video data includes image data;
determining, based on predetermined conditions associated with sampling image data, the frame of video data including the image data as sample image data, wherein the predetermined conditions include the frame of video data representing a change of scenery or when a predetermined time lapses;
transmitting the sample image data for inferencing;
causing, based on the frame of video data, generating reference image data using a teacher model, wherein the reference image data includes a reference label, the reference label infers the frame of video data, and wherein the teacher model generates the reference label by inferencing; and
causing, based on the reference image data, a selection of an image recognition model from a plurality of image recognition models for installation.

20. The device of claim 19, wherein the device represents an edge device of the 5G telecommunication network, and the processor further configured to execute a method comprising:
causing retraining of the image recognition model in a cloud associated with the 5G telecommunication network using a least a part of a set of reference image data.
